(19) United States
(12) Patent Application Publication
(10) Pub. No.: US 2025/0251514 A1
(43) Pub. Date: Aug. 7, 2025

(54) DEVICES AND METHODS FOR VELOCITY ESTIMATION FROM SWEEPS BY A SCANNING LASER DEVICE

(71) Applicant: Microvision, Inc., Redmond, WA (US)

(72) Inventors: Marco J. Nikander, Moenkeberg (DE); Clemens Wuth, Hamburg (DE)

(73) Assignee: Microvision, Inc., Redmond, WA (US)

(21) Appl. No.: 18/624,573

(22) Filed: Apr. 2, 2024

Related U.S. Application Data
(63) Continuation-in-part of application No. 18/433,818, filed on Feb. 6, 2024.

(51) Int. Cl. G01S 17/58; G01S 7/484; G01S 7/4863

(52) U.S. Cl. CPC G01S 17/58; G01S 7/484; G01S 7/4863

(57) ABSTRACT

The embodiments described herein provide systems and methods that can facilitate improved velocity estimation in light detection and ranging (LiDAR) systems and other scanning laser devices. Specifically, the systems and methods utilize laser light pulses to determine estimates of velocity for multiple measurement points in a scanned region. For example, a scanning laser device can be adapted to scan measurement points during temporally adjacent measurement sweeps and generate distance measurements based on the scans made during those sweeps. The scanning laser device is further adapted to interpolate distance measurements to determine distance estimates for measurement points not directly scanned during at least one of the sweeps, and to compare the generated distance estimates to distance measurements taken in the other sweep to determine radial velocity estimates for corresponding measurement points based on the comparison.

### FIELD

The present disclosure generally relates to scanning laser devices and methods, and more particularly relates to light detection and ranging (LiDAR) systems and methods.

### BACKGROUND

Scanning laser devices have been developed and implemented for a wide variety of applications, including object detection. For example, light detection and ranging (LiDAR) systems have been developed for object detection and distance determination. LiDAR systems have also been used to generate 3D maps of surfaces, where the 3D maps describe the variations in depth over the surface. Such object detection, distance determination, and depth mapping have been used in a variety of applications, including navigation and control. For example, such LiDAR devices are being used in the navigation and control of autonomous vehicles, including autonomous devices used for transportation and manufacturing.

In some LiDAR applications there is a desire to further determine motion of detected objects. For example, in some vehicle applications there is a desire to detect and determine the relative motion of detected objects that may cause a safety issue with the vehicle.

Thus, there remains a continuing need for systems and methods that can provide effective determination of motion of detected objects.

### BRIEF DESCRIPTION OF THE DRAWINGS

FIG. 1A shows a schematic diagram of a scanning laser device in accordance with various embodiments;

FIGS. 1B-1C show schematic diagrams of scan patterns in accordance with various embodiments;

FIGS. 2A and 2B show flow diagrams of exemplary methods in accordance with various embodiments;

FIGS. 3A, 3B, and 3C show diagrams of exemplary scan patterns in accordance with various embodiments;

FIG. 4A shows a flow diagram of exemplary methods in accordance with various embodiments;

FIG. 4B shows a schematic view of an object and laser light source in accordance with various embodiments;

FIGS. 5A and 5B show schematic diagrams of a scanning laser device and optical assembly in accordance with various embodiments;

FIGS. 5C and 5D show graphs of optical expansion and a scan trajectory in accordance with various embodiments;

FIG. 6A shows a top view of a moving platform that includes a LiDAR system in accordance with various embodiments;

FIGS. 7A and 7B show side and top views of a scanning laser device in accordance with various embodiments;

FIG. 8 shows a schematic view of a LiDAR system in accordance with various embodiments;

FIG. 9 shows a schematic view of a LiDAR system in accordance with various embodiments;

FIGS. 10A and 10B show a side view and a top view of a transmit module in accordance with various embodiments;

FIGS. 11A and 11B show a side view and a top view of a receive module in accordance with various embodiments; and

FIG. 12 shows a perspective view of an integrated photonics module in accordance with various embodiments of the present invention.

### DESCRIPTION OF EMBODIMENTS

The embodiments described herein provide systems and methods that can facilitate improved velocity estimation in light detection and ranging (LiDAR) systems and other scanning laser devices. Specifically, the systems and methods utilize laser light pulses to determine estimates of velocity for multiple measurement points in a scanned region. And in accordance with the embodiments described herein, these estimates of velocity can be made for these multiple measurement points for each set of temporally adjacent sweeps of the scan field.

In one embodiment a scanning laser device is adapted to scan measurement points during first and second sweeps along a slow-scan axis and generate distance measurements based on the scans made during those first and second sweeps. In such an embodiment the first and second sweeps along a slow-scan axis are temporally adjacent sweeps in opposite directions. The scanning laser device is further adapted to interpolate distance measurements to determine distance estimates for measurement points not directly scanned during at least one of the sweeps, and to compare the generated distance estimates to distance measurements taken in the other sweep along the slow-scan axis to determine radial velocity estimates for corresponding measurement points based on the comparison.

Thus, for each set of temporally adjacent sweeps the scanning laser device can provide velocity estimates for multiple measurement points. In some embodiments, this estimation of velocity for multiple measurement points for each set of temporally adjacent sweeps can be used to discern moving objects from stationary surroundings. Furthermore, this estimation of velocity for multiple measurement points for each set of temporally adjacent sweeps can provide such velocity information with relatively low latency and high frequency. Such low latency information is of particular importance in the context of applications such as autonomous driving, where the “time to interface” constitutes a critical performance indicator, and where there is a need for the determination of trajectory planning and evasive maneuvers within milliseconds.

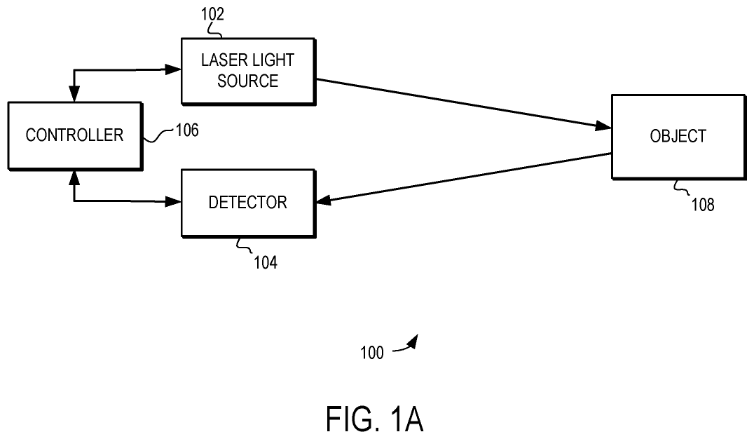

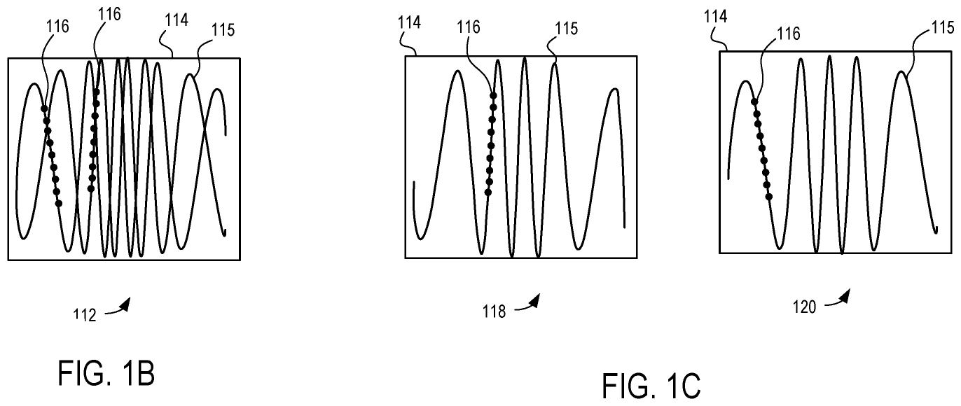

Turning now to FIG. 1A, a simplified schematic diagram of a scanning laser device 100 in accordance various embodiments is illustrated. In one embodiment, the scanning laser device 100 is a light detection and ranging (LiDAR) system used for object detection and/or 3D map generation. The scanning laser device 100 includes a laser light source 102, a detector 104, and at least one controller 106. During operation, the laser light source 102 generates pulses of laser light that are projected into a spatial region referred to as a scan field. These pulses of laser light impact objects (e.g., object 108) in the scan field at multiple scan locations or measurement points. Notably, each “scan location” or “measurement point” is not an infinitely small point in space, but rather a small and finite area of the scan field where one or more pulses impacts an object. The pulses of laser light reflect back from the scan locations or measurement points on the objects. The detector 104 is configured to receive these reflections of the laser light pulses from the scan locations or measurement points on objects within the scan field.

In one embodiment, the scanning laser device 100 can also include beam scanning optics to scan the laser light pulses in a scan field. For example, the scanning laser device 100 can include includes one or more scanning mirror(s). In such embodiments, the scanning mirrors can be implemented as part of an optical assembly, where the optical assembly can further include a variety of other beam scanning optics (e.g., lenses, mirrors, expansion optics, et).

As will be described in greater detail below, these scanning mirror(s) can be configured to scan the pulses of laser light to measurement points along a scan trajectory in the scan field. The scanning mirrors can be further configured to receive reflections of the pulses from the measurement points and direct those reflections to the detector 104.

As specific examples, in some embodiments a first scanning mirror can provide for one axis of motion (e.g., horizontal), while the second scanning mirror provides for another, typically orthogonal, axis of motion (e.g., vertical). Furthermore, in a typical implementation of such an embodiment, the first scanning mirror is operated to provide the scanning motion at one rate (e.g., a relatively slow scan rate), while the second scanning mirror is operated to provide motion at a different rate (e.g., a relatively fast scan rate). Stated another way, the beam scanning optics can include one or more scanning mirrors to scan laser light pulses along a scan trajectory in the scan field, where the scan field includes a slow-scan axis and a fast-scan axis. It further be noted labels “vertical” and “horizontal” used herein are somewhat arbitrary, since a 90 degree rotation of the scanning laser device will effectively switch the horizontal and vertical axes.

In general, the at least one controller 106 controls the operation of the laser light source 102, detector 104 and can control other devices that are part of or coupled to the scanning laser device 100 (e.g., scanning mirrors). Additionally, the at least one controller 106 can perform the operations needed for object detection and/or 3D map generation based at least in part on the reflections received at the detector 104.

For example, the at least one controller 106 can use time-of-flight (TOF) measurements of the received reflections to generate measurement distances. As one specific example, these measurement distances can be used to generate 3-dimensional point clouds that describe the depth or distance at each point, and thus can be used to generate a depth map of any detected objects (e.g., object 108). And as will be described in greater detail below, the at least one controller 106 can be implemented to determine radial velocity estimates for measurement points using distance measurements from temporally adjacent sweeps and the time delta between sweeps.

As used herein, the term “radial velocity estimate” is an estimate for that component of (or contribution to) the object velocity along the laser-light direction relative to the scanning laser device 100. Stated another way, the estimated radial velocity is an estimate of the object velocity at a measurement point on the object, where the radial velocity is referenced along a vector between the scanning laser device and the measurement point. As will be discussed in greater detail below, the embodiments described herein can provide a radial velocity estimate for each of a plurality of measurement points on an object for each set of temporally adjacent sweeps.

The at least one controller 106 can be implemented with any suitable combination of hardware and/or software. For example, the at least one controller 106 can be implemented with a variety of processing devices, including one or more digital processors, one or more programmable controllers, specialized hardware devices, and any combination therein.

In accordance with the embodiments described herein, the at least one controller 106 is adapted to determine radial velocity estimates for measurement points using distance measurements from temporally adjacent sweeps. For example, the at least one controller 106 can be adapted to scan first measurement points with laser light pulses to generate a first plurality of distance measurements for a first sweep along a slow-scan axis based on times-of-flight of detected reflections, and to scan second measurement points with laser light pulses to generate a second plurality of distance measurements for a second sweep along a slow-scan axis based on times-of-flight of detected reflections.

The at least one controller 106 is further adapted to interpolate the first plurality of distance measurements to determine a first plurality of distance estimates. Specifically, this interpolation of distance measurements generates distance estimates for points not directly scanned during the first sweep along a slow-scan axis. The at least one controller 106 is further adapted to compare the generated distance estimates in the first plurality of distance estimates to distance measurements in the second plurality of distance measurements and to determine radial velocity estimates for corresponding measurement points based on the comparison.

As was noted above, the first sweep along a slow-scan axis and the second sweep along a slow-scan axis are temporally adjacent. Thus, for each set of temporally adjacent sweeps the at least one controller 106 can provide velocity estimates for multiple measurement points. Again, this estimation of velocity for multiple measurement points can provide such velocity information with relatively low latency and high frequency. Furthermore, in some embodiments the velocity information for each set of temporally adjacent sweeps can facilitate object tracking or perception algorithms. For example, the velocity information can be used in generating dynamic occupancy grids to distinguish between stationary and moving objects with greater certainty, which can improve the quality and safety of the perception results.

In one more specific embodiment, the at least one controller can be further adapted to interpolate second distance measurements in the second plurality of distance measurements to determine a second plurality of distance estimates and to compare distance estimates in the second plurality of distance estimates to distance measurements in the first plurality of distance measurements to determine radial velocity estimates for corresponding measurement points.

In another more specific embodiment, the at least one controller can be adapted to compare the distance estimates in the first plurality of distance estimates to the distance measurements in the second plurality of distance measurements to determine the radial velocity estimates for the corresponding measurement points by being further adapted to interpolate second distance measurements in the second plurality of distance measurements to determine a second plurality of distance estimates and compare the distance estimates in the first plurality of distance estimates to distance estimates in the second plurality of distance estimates to distance measurements in the first plurality of distance measurements to determine the radial velocity estimates for the corresponding measurement points.

In one more specific embodiment, the at least one controller can be further adapted to determine a surface-normal velocity from at least one of the radial velocity estimates. For example, the at least one controller can be adapted to determine a surface-normal vector of a surface at the measurement point and project the at least one radial velocity estimate onto the surface-normal vector.

The scanning laser device 100 can be adapted to scan the laser light pulses in the scan region using a variety of techniques and patterns. Furthermore, a variety of different techniques and patterns can be used to interpolate the distance measurements to determine distance estimates and to compare the generated distance estimates to distance measurements to determine radial velocity estimates for corresponding measurement points based on the comparison.

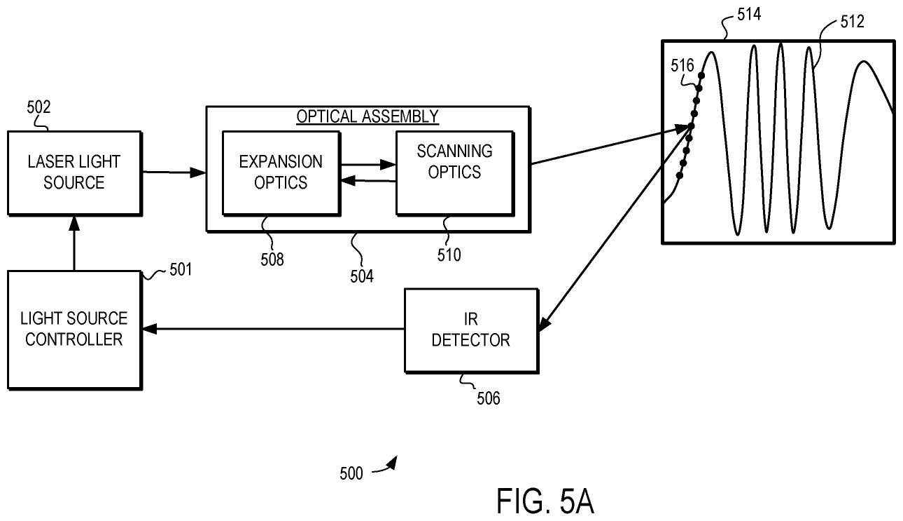

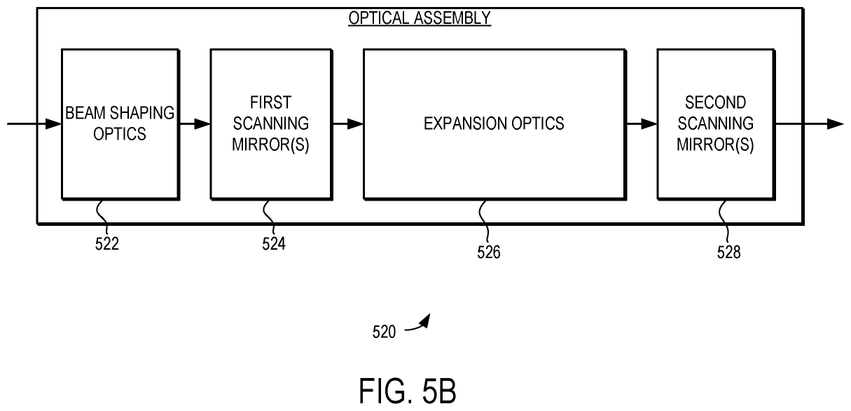

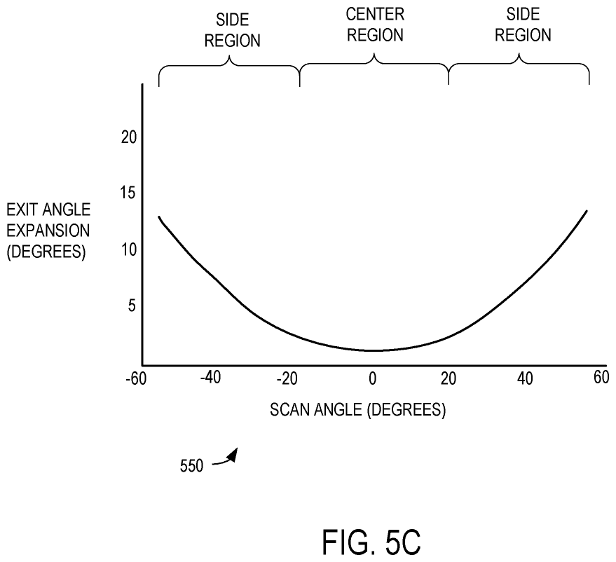

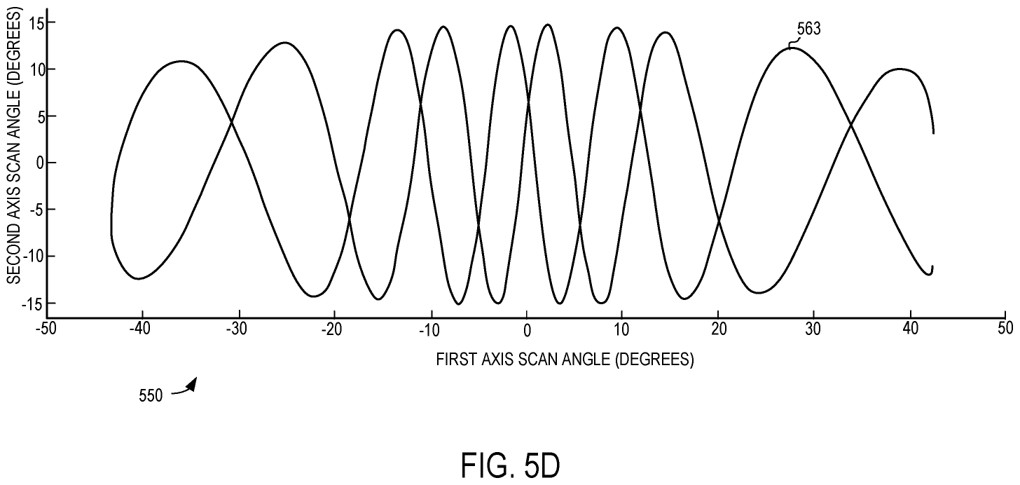

Turning now to FIG. 1B, a scan pattern 112 in a scan field 114 is illustrated schematically. In the example of FIG. 1B the scan pattern 112 includes a plurality of measurement points 116 (illustrated as black circles) that are impacted by laser light pulses during scanning. In this illustrated example the measurement points 116 in the scan pattern 112 are arranged along scan trajectory 115, although this is just one example of such a scan trajectory 115. Specifically, in the example of FIG. 5A, the scan trajectory 115 in the scan field 114 comprises a modified sinusoidal-type pattern. However, this is just one example, and in other embodiments other trajectories or patterns of scan lines can be generated as used. Finally, it should be noted that that for clarity purposes not all measurement points 116 along the scan trajectory 115 are illustrated with a black circle.

Notably, the scan pattern 112 illustrates measurement points 116 that are scanned during two temporally adjacent sweeps of the scan field 114.

Turning now to FIG. 1C, scan patterns 118 and 120 for two temporally adjacent sweeps of the scan field 114. In this example scan patterns 118 and 120 each provide spatially offset sets of measurement points, where the alternating spatially offset sets are at least substantially interleaved together. Stated another way, the scan patterns 118 and 120 are at least partially spatially complementary, and thus taken together provide higher resolution coverage of the scan field 114.

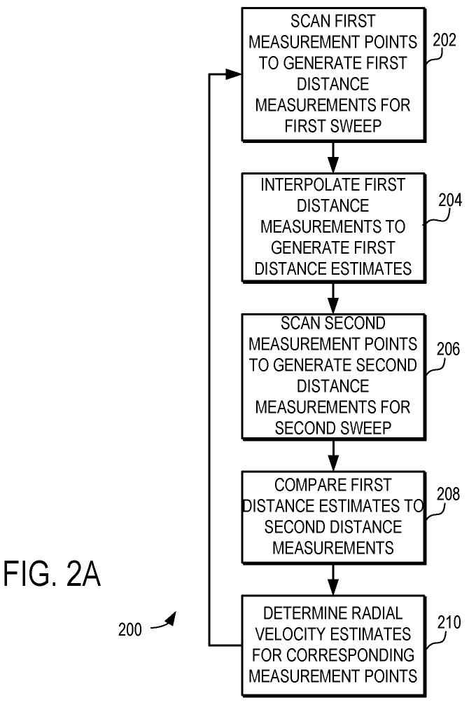

Turning now to FIG. 2A, a flow diagram illustrates a method 200 in accordance with various embodiments. In some embodiments, method 200, or portions thereof, is performed by a LiDAR or other scanning laser device (e.g., scanning laser device 100, 500). For example, method 200 can be performed by a series of circuits or an electronic system that is part of, in communication with, or otherwise associated with a scanning laser device. Thus, method 200 is not limited by the particular type of apparatus performing the method.

At step 202 first measurement points are scanned with laser light pulses to generate a first plurality of distance measurements for a first measurement sweep based on times-of-flight of detected reflections. As described above, in one embodiment step 202 is performed with scanning laser device that includes beam scanning optics to scan the laser light pulses in a scan field. For example, the scanning laser device can include one or more scanning lasers that scan laser light pulses along a scan trajectory, and where the scan field includes a slow-scan axis and a fast-scan axis. In such an embodiment the first plurality of distance measurements for a first measurement sweep will be determined in part by the arrangement and operation of these beam scanning optics.

In one example, step 202 is performed by scanning laser pulses during a “first” or “forward” sweep and receiving reflections at corresponding sensor elements. It should be noted that in these embodiments the time differences between pulses during this first sweep can be relatively small compared to the time differences between first and second (or forward and return) sweeps.

Of course, these are just some examples of the types of scan patterns and implementations that may be used in generating the first plurality of distance measurements for the first sweep.

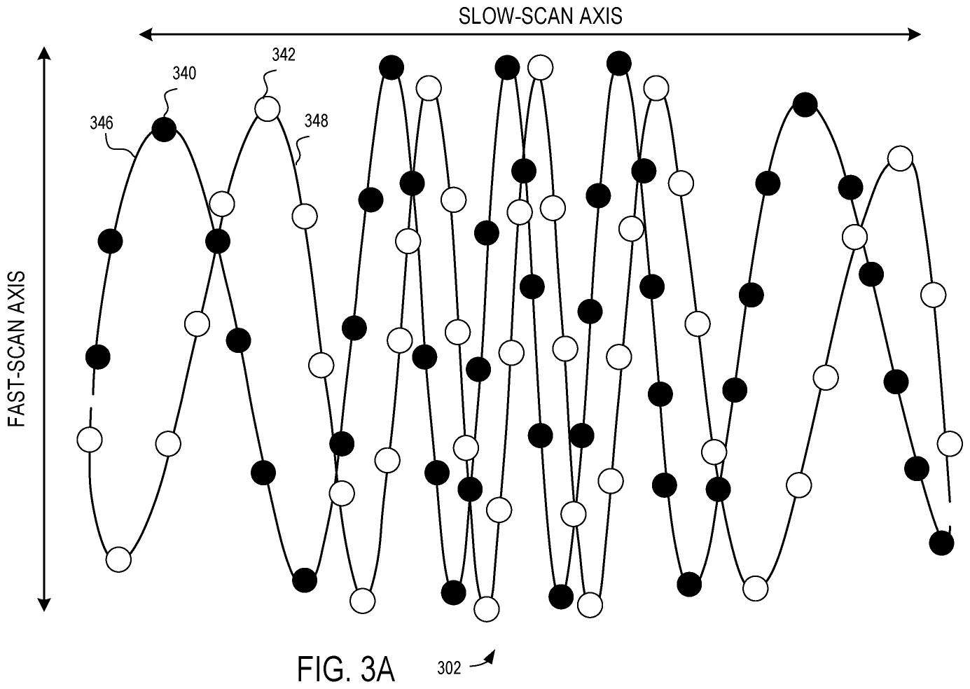

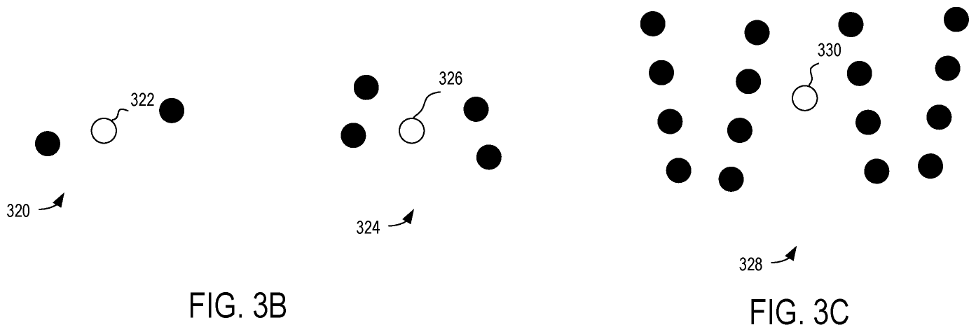

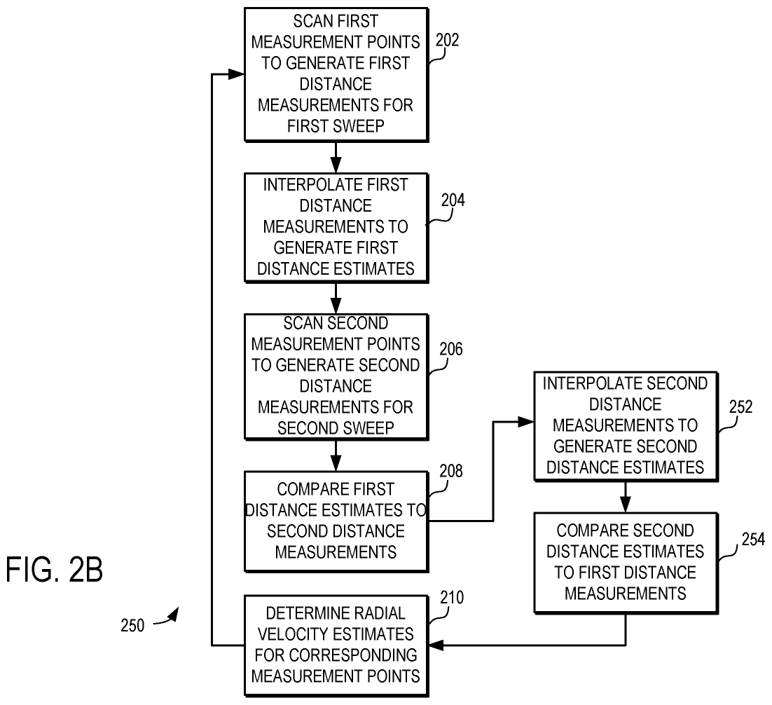

Turning briefly to FIG. 3A, an example of such a scan pattern is illustrated schematically. Specifically, FIG. 3A shows a portion of a scan pattern 302 where alternating groups of measurement points are scanned in the first sweep (e.g., during step 202 of method 200). In FIG. 3A the black circles 340 represent measurement points for which distance measurements are generated in the first sweep in along a scan trajectory 346. Notably, this first sweep is in the direction of the slow-scan axis. Thus, in FIG. 3A the black circles 340 represent measurement points that are scanned and used to generate a first plurality of distance measurements. The white circles 342 represent measurement points that are not scanned in this first sweep, but as will be described below, those measurement points will be scanned in a second or return sweep. It should be noted that FIG. 3B is a simplified example, and that in a typical implementation many more measurement points could be scanned in the first sweep.

Returning to FIG. 2A and method 200, at step 204 the first plurality of distance measurements are interpolated to generate a first plurality of distance estimates. In this step the interpolation of distance measurements is used to generate first distance estimates for measurement points not scanned during the first sweep. In the examples of FIG. 3A this corresponds to measurement points represented with white circles 342. Stated another way, the distance measurements for measurement points scanned in the first sweep (represented with black circles 340) are used to generate distance estimates for measurement points not scanned in the first sweep (represented with white circles 342). Consequently, the distance measurements for measurement points scanned in the first sweep are used to generate distance estimates for measurement points not scanned in the first sweep, but as will be described below, those measurement points will be scanned in the second or return sweep. However, it should be noted that in some implementations of step 204 distance estimates are not generated for all measurement points that were not scanned in the first, and instead distance estimates may only be generated for a subset of the unscanned measurement points that will be scanned in the second or return sweep.

In general, step 204 uses interpolation to generate distance estimates for measurement points using the first distance measurements for neighboring or nearby measurement points that were scanned in step 202. A variety of different techniques can be used to perform the interpolations of step 204. For example, a variety of linear and planar interpolation techniques may be used to generate the distance estimates. As other examples, non-linear interpolation, polynomial interpolation, feature extraction, or statistical techniques may be used generating distance estimates.

As examples of various interpolation techniques, the distance measurements and relative scan field locations for measurement points near the point be estimated can be used to define a curve, surface, plane, line, or other interpolation feature. That interpolation feature can then be used to estimate the distance the point. It should be noted that in these examples the relative scan field location of the measurement points can be determined based in part on the displacement angle of the mirror(s) at the time of the corresponding laser light pulse. And again, these relative locations can then be used in the interpolation used to generate the distance estimate.

In various embodiments a variety of different combinations of distance measurements may be used in the interpolations of step 202. In these various embodiments different subsets of distance measurements from different “neighborhoods” having different “neighborhood sizes” may be used. For example, in some embodiments only distance measurements for directly adjacent measurement points can be used for interpolation. In other examples, distance measurements from other measurement points that are non-adjacent in the scan field may also be used. These other measurement points that are not adjacent to the current measurement point in the image plane are each at a farther distance from the current measurement point than adjacent measurement points but can still be used to interpolate and generate distance estimates for the current measurement point. And in other examples, distance measurements from measurement points at different relative angles and/or relative distances may be used. And in yet other examples, combinations of the above examples may be used.

It should be noted that the interpolation technique used in step 204 to generate the distance estimate would typically depend on the number of distance measurements used and the relative positioning of those distance measurements. For example, distance measurements from closer measurement points can be weighted higher than those from farther measurement points.

Finally, it should be noted that different interpolation techniques may be used for different points within the same sweep of the scan field. For example, more measurement points may be used for distance estimates in areas of the scan field where the density of the points is greater (e.g., near the center) compared to areas where the density of the points is less (e.g., near the edges).

Turning briefly to FIGS. 3B and 3C, examples of distance measurements that may be used for interpolation are illustrated schematically. Specifically, FIG. 3B shows examples 320, 324 of measurement points from scan trajectories, where the black circles represent measurement points for which first distance measurements can be used to interpolate a first distance estimate for the measurement point represented by the white circles 322, 326.

Specifically, in example 320 distance measurements for two nearby or adjacent measurement points are used to generate the distance estimate for measurement point indicated by white circle 322. In example 324 distance measurements for four nearby or adjacent measurement points measurement points are used to generate the distance estimate for measurement point indicated by white circle 326. Again, these are just two examples, and many other implementations and configurations are possible.

FIG. 3C likewise shows example 328 of measurement points, where the black circles again represent measurement points for which distance measurements can be used to interpolate a distance estimate for the measurement point represented by the white circle 330.

In example 328 distance measurements for sixteen measurement points are used to generate the distance estimate for the measurement point indicated by white circle 330. In example 328 distance measurements for eight measurement points from adjacent portions of the scan trajectory and eight measurement points from farther portions of the scan trajectory are used to generate the distance estimate for measurement point 330. Again, these other farther measurement points that are not directly adjacent to the current measurement point 330 in the scan region. Thus, these farther measurement points are a greater distance from the current measurement point 330 in the image plane (compared to the adjacent measurement points used in examples 320 and 324) but can still be used to interpolate and generate distance estimates for the current measurement point 330. Again, FIG. 3C is just one example, and many other implementations and configurations are possible.

And again, in some embodiments different interpolation techniques may be used for different points within the same sweep of the scan field. For example, more measurement points as shown in FIG. 3C may be used for distance estimates near the center of the scan field, while less measurement points as shown in FIG. 3B may be used for distance estimates near the edges of the scan field.

At step 206, the second set of measurement points are scanned with laser light pulses to generate a second plurality of distance measurements for a second measurement sweep based on times-of-flight of detected reflections. In this step, the second measurement points scanned in step 206 include or correspond to at least some of the measurement points for which distance estimates were generated in step 204.

In one embodiment step 206 is performed with scanning laser device that includes beam scanning optics to scan the laser light pulses in a scan field. Again, the scanning laser device can include one or more scanning lasers that scan laser light pulses along a scan trajectory, and where the scan field includes a slow-scan axis and a fast-scan axis. In such an embodiment the second plurality of distance measurements for a second measurement sweep will be determined in part by the arrangement and operation of these beam scanning optics.

Again, in one example, step 206 is performed by scanning laser pulses during a “second” or “return” sweep and receiving reflections at corresponding sensor elements. It should again be noted that in these embodiments the time differences between pulses during this second sweep can be relatively small compared to the time differences between first and second (or forward and return) sweeps.

The second measurement points scanned in step 206 thus include or correspond to at least some of the measurement points that were not scanned in step 202 and for which distance estimates were generated in step 204. In the example of FIG. 3A the “second” or “return” sweep can follow the trajectory 348 and thus be used to generate measurements for measurement points 342.

And again, it should be noted that the first measurement sweep in step 202 and the second measurement sweep in step 206 are temporally adjacent sweeps of the scan field.

At step 208 the generated first distance estimates in the first plurality of distance estimates are compared to distance measurements in the second plurality of distance measurements. Notably, in step 208 the distance estimates for each of a plurality of measurement points during one sweep are compared to the corresponding distance measurements made for those same measurement points during another sweep, where the sweeps are temporally adjacent sweeps.

Thus, the plurality of distance measurements made in the first sweep (step 202) are used to generate a plurality of distance estimates (step 204), and a plurality of distance measurements made in the second sweep (step 206) are now each compared during to a corresponding distance estimate in the plurality of distance estimates during step 208.

Returning briefly to the examples of FIG. 3A, distance measurements made in the first sweep for the measurement points represented by black circles 340 (generated in step 202) are used to generate a plurality of distance estimates for the measurement points represented by white circles 342 (in step 204). Distance measurements are made in the second sweep for the measurement points represented by white circles 342 (in step 206). In step 208 the plurality of distance estimates generated are now each compared to a corresponding distance measurement made in the second sweep. Thus, in this example, for each measurement point represented by a white circle 342, a distance estimate from one sweep is compared to a distance measurement generated from a second, temporally adjacent sweep.

In step 208 the distance measurements and distance estimates can be compared in various ways. For example, step 204 can be performed by determining the difference between each distance estimate and the corresponding distance measurement for the same measurement point. In some embodiments additional information can be used in step 204. For example, the relative “intensity” of received reflections may be used in some determinations.

At step 210 radial velocity estimates are determined for corresponding measurement points based on the comparison. In general, step 210 can be performed by determining a radial velocity estimate for each of a plurality of measurement points. Thus, for each of a plurality of measurement points a comparison of the distance measurement to the distance estimate for that point can be performed, and a radial velocity estimate for that point determined from the comparison.

As one example, where the comparison in step 208 generates a distance difference between each distance estimate and the corresponding distance measurement, that distance difference and the time delta between the time of the first distance measurement (in step 202) and the second distance measurement (in step 206) can be used to generate a radial velocity estimate for the corresponding measurement point. Notably, in this example the time delta between measurements is also the time period between the temporally adjacent sweeps.

Returning briefly to the example of FIG. 3A, distance differences for each measurement point represented by a white circle 342 can be generated in step 208 from the distance estimate generated in step 204 and the second distance measurement generated in step 206, and those distance differences can be used to generate radial velocity estimate for each measurement point represented by a white circle 342.

Steps 202, 204, 206, 208 and 210 can be continuously repeated to generate radial velocity estimates for corresponding measurement points. Notably, this technique facilitates the determination of radial velocity estimates for each of a plurality of measurement points during each set of two temporally adjacent sweeps.

It should be noted that the order of the steps illustrated in FIG. 2A are merely illustrative of one example and can be modified in other embodiments. For example, in some embodiments, step 206 can be before step 204. Furthermore, in various embodiments one or more steps can be performed simultaneously. For example, step 204 can be performed during times when step 206 is also being performed. Likewise with steps 208 and 210. Thus, it should be understood that the order illustrated in FIG. 2A is just one example embodiment, and that other embodiments are possible.

In some embodiment, the method 200 of FIG. 2A can be expanded to generate radial velocity estimates for more measurement points. Specifically, while method 200 as described above effectively generates radial velocity estimates for a portion of the measurement points (i.e., those points for which distance estimates were generated in step 202), the method 200 can be expanded to generate more measurement points by interpolating distance estimates for more measurement points and comparing those distance estimates to more distance measurements and using that comparison to generate more radial velocity estimates. As one example, the method 200 can be expanded to also generate radial velocity elements for at least a plurality of measurement points represented by black circles in FIG. 3A.

Turning now to FIG. 2B, a flow diagram illustrates a method 250 in accordance such embodiments. Again, this method 250, or portions thereof, is performed by a LiDAR or other scanning laser device (e.g., scanning laser device 100, 500). Compared to method 200, the method 250 adds additional steps to generate more radial velocity estimates for more measurement points.

Specifically, method 250 includes the steps 202, 204, 206, 208 and 210 as described above. However, method 250 also includes additional steps 252 and 254 between steps 208 and 210. In step 252 a second plurality of distance measurements are interpolated to generate a second plurality of distance estimates. Specifically, in this step 252 the interpolation of distance measurements is used to generate second distance estimates for measurement points that were not estimated in the previous step 204 and not directly scanned during the second measurement sweep in the previous step 206. In the examples of FIG. 3A this corresponds to measurement points represented with black circles 340. Stated another way, the distance measurements for measurement points scanned in the second or return sweep (represented with white circles 342) are used to generate distance estimates for measurement points not scanned in the second sweep (represented with black circles 340). However, it should again be noted that in some implementations of step 252 distance estimates are not generated for all measurement points that were not scanned in the second sweep, and instead distance estimates may only be generated for a subset of the unscanned measurement points.

Again, step 252 uses interpolation to generate a distance estimate for each of these measurement points using the second distance measurements generated for neighboring or nearby measurement points that were scanned in step 206. And as with step 204, a variety of different techniques can be used to perform the interpolations of step 252 (including those illustrated in FIGS. 3C and 3D).

At step 254 the generated second distance estimates in the second plurality of distance estimates are compared to distance measurements in the first plurality of distance measurements. Again, in step 254 the distance estimates for each of a plurality of measurement points during one sweep are compared to the corresponding distance measurements made for those same measurement points during another sweep, where the sweeps are temporally adjacent sweeps.

Thus, the plurality of distance measurements made in the first sweep (step 202) are used to generate a plurality of distance estimates (step 204), and a plurality of distance measurements made in the second sweep (step 206) are each compared to a corresponding distance estimate in the plurality of distance estimates during step 208. And the plurality of distance measurements made in the second sweep (step 206) are used to generate a second plurality of distance estimates (step 252), and a plurality of distance measurements made in the first sweep (step 202) are each compared to a corresponding distance estimate in the second plurality of distance estimates during step 254.

At step 210 radial velocity estimates are determined for corresponding measurement points based on the comparison as was described with reference to method 200 above. Again, step 210 can be performed by determining a radial velocity estimate for each of a plurality of measurement points. Thus, for each of a plurality of measurement points a comparison of the distance measurement to the distance estimate for that point can be performed, and a radial velocity estimate for that point determined from the comparison.

Returning briefly to the example of FIG. 3A, distance differences for each measurement point represented by a white circle 342 can be generated in step 208 from the distance estimate generated in step 204 and the second distance measurement generated in step 206. Likewise, distance differences for each measurement point represented by a black circle 340 can be generated in step 254 from the distance estimate generated in step 252 and the first distance measurement generated in step 202. Those distance differences can be used to generate radial velocity estimate for each measurement point represented by a white circle 342 or a black circle 340.

Steps 202, 204, 206, 208, 252, 254 and 210 can be continuously repeated to generate radial velocity estimates for corresponding measurement points. Notably, this technique facilitates the determination of radial velocity estimates for each of a plurality of measurement points during sets of temporally adjacent sweeps.

As described above, various techniques can be used to determine radial velocity estimates for each of a plurality of measurement points during sets of temporally adjacent measurements sweeps. And as also described above, these radial velocity estimates each provide a measure of the object velocity at the corresponding measurement point on the object, where the radial velocity is referenced along a vector between the scanning laser device and the measurement point. However, a variety of other measurements and estimates can also be determined in various embodiments.

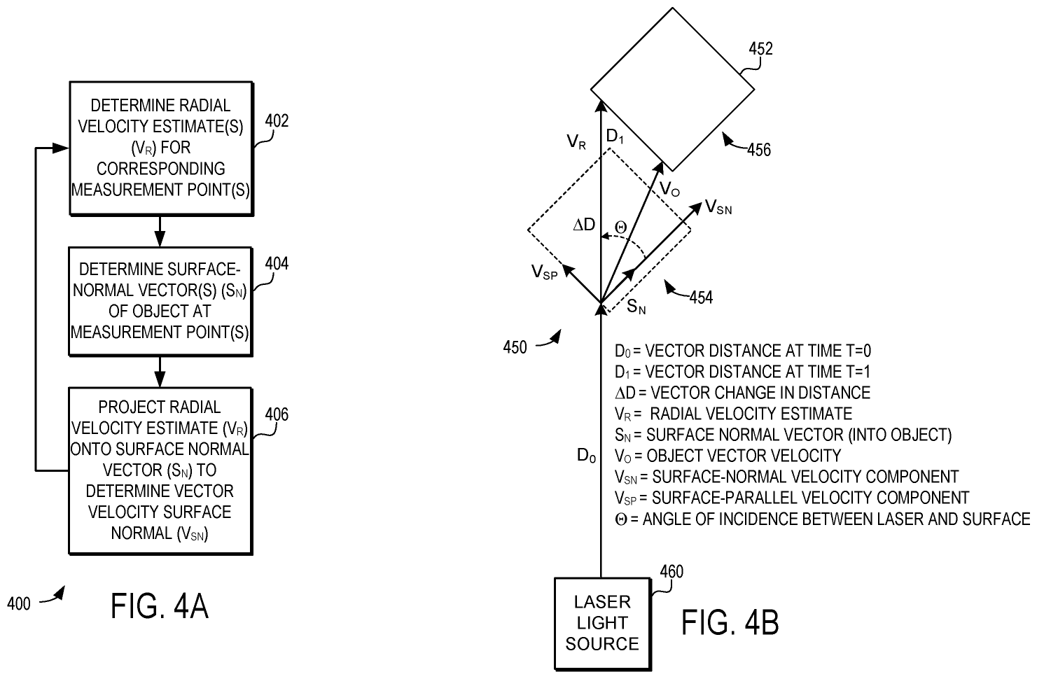

Turning now to FIGS. 4A and 4B, a method 400 and schematic diagram 450 illustrate a technique for determining a measure of velocity of a surface of the object. Specifically, the method can facilitate the determination of a normal component of surface velocity, referred to herein as a surface-normal velocity (V_{SN}).

Beginning with FIG. 4A and method 400, in step 402 radial velocity estimate(s) (V_{R}) for one or more measurement points are determined. In general, these radial velocity estimate(s) can be determined for the measurement points(s) on an object using any of the techniques described herein, including methods 200 and 250 described above. Thus, the radial velocity estimates (V_{R}) can be determined from scans of measurement points during first and second measurement sweeps, distance measurements and distance estimates determined from those scans, and comparisons of the generated distance estimates to distance measurements.

Turning now to FIG. 4B, a schematic diagram 450 illustrates an example top view of an object moving from position 454 at time T=0 to a second position 456 at time T=1. In this example, a first distance D₀ at time T=0 is determined by a first distance measurement or first distance estimate. Likewise, a second distance D₁ at time T=1 is determined by a second distance estimate or second distance measurement. A change in the distance between first distance D₀ and second distance D₁ is represented as ΔD. Notably, in this example the time T=0 corresponds to a first sweep of measurements, and time T=1 corresponds a second sweep of measurements. Thus, the change in distance ΔD can be determined in two temporally adjacent sweeps and used to determine the radial velocity estimate (V_{R}). Again, this radial velocity estimate (V_{R}) is referenced along a vector between the laser light source 460 and the measurement point on the object 452.

Returning to FIG. 4A, in step 404, a surface-normal vector(s) (S_{N}) of the object is determined for the measurement point(s). In general, the surface-normal vector (S_{N}) for a measurement point can be determined from the distance measurements for a group of surrounding measurement points. For example, a group of three or more distance measurements for nearby measurement points can be used to determine a surface plane, where the surface is plane is defined as the plane passing through the group of points determined from the distances. And likewise, a surface-normal vector (S_{N}) that corresponds to the object surface at the measurement point can be determined from the distances to the nearby measurement points.

Returning to FIG. 4B, the schematic diagram 450 illustrates an example of a surface-normal vector (S_{N}) for a measurement point. Again, this surface-normal vector (S_{N}) for a measurement point can be determined from the distance measurements for a group of surrounding measurement points.

Returning to FIG. 4A, in step 406 the radial velocity estimate (V_{R}) for a measurement point is projected onto the surface-normal vector (S_{N}) for the measurement point to determine a surface-normal velocity (V_{SN}) of the measurement point. In this step, vector algebra can be used to perform the projection and determine the surface-normal velocity (V_{SN}) of a measurement point from the radial velocity estimate (V_{R}) and the surface-normal vector (S_{N}).

Returning to FIG. 4B, the schematic diagram 450 illustrates an example of a surface-normal velocity (V_{SN}) of the measurement point determined by projecting the radial velocity estimate (V_{R}) for a measurement point onto the surface-normal vector (S_{N}). When determined, the surface-normal velocity (V_{SN}) of the measurement point can be used to provide a more accurate assessment of the object velocity. Specifically, the surface-normal velocity (V_{SN}) also provides velocity direction/orientation information that can be useful for some applications where it can be assumed that the object moves either parallel or perpendicular to the surface normal. Furthermore, in cases where two surfaces belong to the same object, the techniques can estimate both surface-normal velocities (V_{SN}) and can further compute the angle between those surfaces from the distance data, which can be then be used to determine the velocity vector of an object.

It should be noted that surface-normal velocity (V_{SN}) is just one example of the type of velocity that can be determined using the techniques described herein.

Turning now to FIGS. 5-12, a variety of detailed examples of exemplary scanning laser devices will be described. These examples include various specific embodiments of the type of scanning laser devices that can be implemented to generate distance measurements from temporally adjacent sweeps in accordance with the embodiments described herein. However, it should be noted that these are just non-limiting examples of the type of scanning laser devices that can be so implemented.

Turning now to FIGS. 5A and 5B, schematic diagrams of a scanning laser device 500 in accordance various embodiments is illustrated. In one embodiment, the scanning laser device 500 is a light detection and ranging (LiDAR) system used for object detection and/or 3D map generation. The scanning laser device 500 includes a light source controller 501, a laser light source 502, an optical assembly 504, and a detector 506. The optical assembly 504 includes a variety of beam scanning optics for laser scanning, including expansion optics 508 and scanning optics 510. During operation, the laser light source 502 generates pulses of laser light that are scanned by the optical assembly 504 along a scan trajectory 512 inside a scan field 514.

These pulses of laser light impact objects in the scan field 514 in a series of scan locations or measurement points 516 along the scan trajectory 512. The detector 506 is configured to receive reflections of the laser light pulses from the scan locations or measurement points 516 on objects within the scan field 514. The received reflections of the laser light pulses can be used to detect the objects within the scan field 514. For example, time-of-flight (TOF) measurements of the received reflections can be used to generate measurement distances. As one example, these measurement distances can be used to generate 3-dimensional point clouds that describe the depth or distance at each point, and thus can be used to generate a depth map of any detected objects.

To facilitate the generation of the scan trajectory 512, a drive circuit can be implemented to controls the movement of scanning optics 510 while the expansion optics provide any desired optical expansion, including exit pointing angle expansion, beam width expansion, and bean divergence. Detailed examples of such devices will be described in greater detail below.

In addition to the detector 506 in some embodiments the scanning laser device 100 is implemented to include one or more additional detectors. For example, a second detector can be implemented to receive reflections of the IR laser light pulses from within the scan field through the optical assembly 504.

The scanning laser device 500 can also include other elements. For example, the scanning laser device 500 can also include time-of-flight (TOF) circuitry responsive to the detector 506 to measure distances to objects at the depth measurement points 516 in the scan field.

Turning now to FIG. 5B, a more detailed embodiment of an optical assembly 520 is illustrated. The optical assembly 520 includes optical elements used for scanning laser beam pulses over a scan field. The optical assembly 520 is an example of the type of optical assembly that can be used in a LiDAR or other scanning laser device (e.g., scanning laser device 100, 500) in accordance with the embodiments described herein. The optical elements illustrated in FIG. 5B includes beam shaping optics 522, first scanning mirror(s) 524, expansion optics 526, and second scanning mirror(s) 528, although this is just one non-limiting example. Again, during operation of a scanning laser device a laser light source generates laser light pulses that are scanned by the optical assembly 520 into a scan trajectory (e.g., scan trajectory 512) over a scan field (e.g., scan field 514).

For example, the laser light source can comprise one or more infrared (IR) lasers implemented to generate IR laser light pulses. In one specific example, the pulses from multiple IR laser light sources are combined and shaped by beam shaping optics 522. The beam shaping optics 522 can include any optics for changing the beam shape of the laser light pulses. For example, the beam shaping optics 522 can include optical elements for changing the beam shape, changing the beam collimation, combining multiple beams, and aperturing the beam(s).

The output of the beam shaping optics 522 is passed to the first scanning mirror 524. In general, the first scanning mirror 524 provides for one axis of motion (e.g., horizontal), while the second scanning mirror 528 provides for another, typically orthogonal, axis of motion (e.g., vertical). Thus, the first scanning mirror 524 scans the laser beam pulses across one direction (e.g. horizontal), while the second scanning mirror 528 scans across the other direction (e.g., vertical). Furthermore, in a typical implementation of such an embodiment, the first scanning mirror 524 is operated to provide the scanning motion at one rate (e.g., a relatively slow scan rate), while the second scanning mirror 528 is operated to provide motion at a different rate (e.g., a relatively fast scan rate). Together, this results in the laser light pulses being scanned into scan trajectory (e.g., scan trajectory 512). It further be noted labels “vertical” and “horizontal” used herein are somewhat arbitrary, since a 90 degree rotation of the scanning laser device will effectively switch the horizontal and vertical axes.

The output of the first scanning mirror 524 is passed to the expansion optics 526. In general, the expansion optics 526 are implemented to provide an expansion of the scan field in one or more directions. For example, the expansion optics 526 can be implemented to provide an angular expansion along the axis of motion of the first scanning mirror 524. Thus, in one example where the first scanning mirror 524 provides relatively slow speed scanning along the horizontal axis, the expansion optics 526 can be implemented to increase the scanning angle along in the horizontal direction. As one specific example, the first scanning mirror 524 can be implemented to provide a scanning angle in the horizontal direction of 40 degrees, and the expansion optics 526 can be implemented to expand the scanning angle to 110 degrees, thus expanding the size of the resulting scan trajectory and scan field.

To provide this expansion the expansion optics 526 can be implemented with one or more lenses, with the one or more lenses configured to together provide the desired angular expansion. In one specific example, the expansion optics 526 is implemented with three separate lenses. A description of such an embodiment will be described in greater detail below.

The output of the expansion optics 526 is passed to the second scanning mirror 528. Again, the first scanning mirror 524 provides for one axis of motion (e.g., horizontal), while the second scanning mirror 528 provides for another, typically orthogonal, axis of motion (e.g., vertical). Furthermore, the first scanning mirror 524 and second scanning mirror 528 operate at different scan rates. In one specific embodiment the second scanning mirror 528 provides vertical high rate scanning, while the first scanning mirror 524 provides horizontal low rate scanning.

During operation, optical assembly 520 thus operates to receive laser light pulses and scan those laser light pulses into a scan trajectory pattern inside a scan field.

Turning now to FIG. 5C, a representation of optical expansion in a scan field is illustrated in graph 550. Specifically, graph 550 shows the exit pointing angle expansion as a function of the scan angle along a first axis, where the first axis also corresponds to a first axis in the resulting scan field. This exit angle expansion is an example of the type of optical expansion that can be provided by the expansion optics of a scanning laser device (e.g., expansion optics 508 of FIG. 5A). The optical expansion illustrated in graph 550 is non-uniform relative to a first axis, and more specifically results in a non-linear optical expansion relative to an axis in the scan field. This non-uniform and non-linear optical expansion results in a higher rate of optical expansion variation in the side regions of the scan field along the first axis compared to the lower rate of optical expansion variation in the center region. This is shown by the increasingly steep slopes of the function curve as distance from the center increases.

Turning now to FIG. 5D, a graph 560 illustrates an exemplary scan trajectory 563. During operation of the scanning laser device laser light pulses impact objects in a series of scan locations or measurement points along the scan trajectory 563. The scan trajectory 563 is an example of the type of scan trajectory that can be generated with a scanning laser device that includes expansion optics that provide a non-uniform optical expansion with respect to a first axis (e.g., expansion optics 526 of FIG. 5A). More specifically, the scan trajectory 563 is an example of the type of trajectory that can be generated with an optical expansion such as that illustrated in graph 550 of FIG. 5B. Thus, this scan trajectory 563 shows the result of a non-uniform and non-linear optical expansion where a higher rate of exit angle expansion variation is created in the side regions of the scan field along the first axis compared to the lower rate of exit angle expansion variation created in the center region.

The scan trajectory 563 is generated by the motion of one or more scanning mirror(s), with the mirror(s) providing deflection of the laser light pulses along a first axis and a second axis, with the non-uniform expansion provided by one or more expansion optics. In this illustrated example, the scanning motion in the first axis is relatively slow motion, while the scanning motion in the second axis is relatively fast motion. Also, in this example the motion in the first axis is horizontal, while the motion in the second axis is vertical (although again it should be noted that the labels “vertical” and “horizontal” are somewhat arbitrary).

Finally, it should be noted that the scan trajectory 563 is just one example trajectory that can result from non-uniform variations in optical expansion, and that many other implementations are possible.

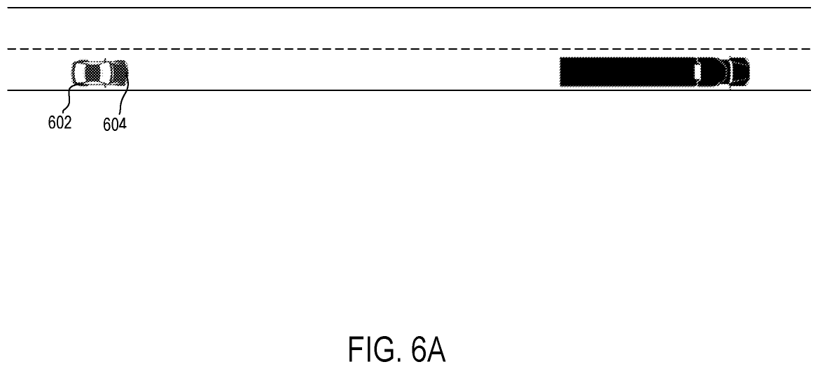

Turning now to FIG. 6, one application of a scanning laser device (e.g., scanning laser device 100) is illustrated. Specifically, FIG. 6A illustrate a moving platform with scanning LiDAR system in accordance with various embodiments. Automobile 602 is a movable platform upon which a LiDAR system 604 is mounted. The LiDAR system is implemented using the various embodiments discussed above. (e.g., scanning laser device 100 of FIG. 1) or any of the scanning laser devices and LiDAR systems discussed herein.

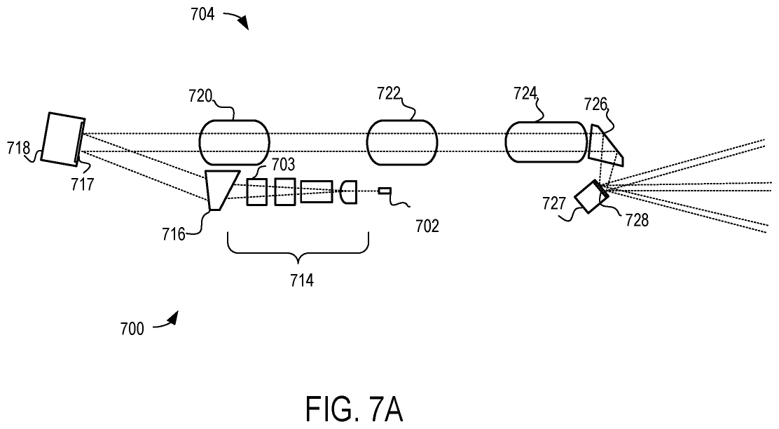

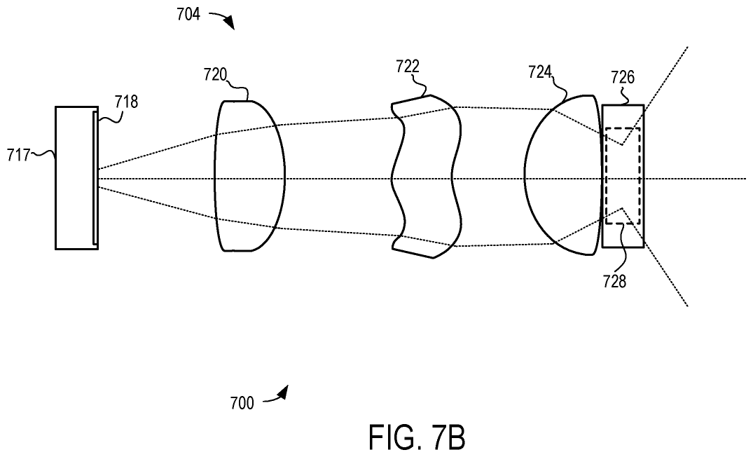

Turning now to FIGS. 7A and 7B, side and top views of an exemplary scanning laser device 700 are illustrated. The scanning laser device 700 is an example of the type of device that can be implemented with the techniques described above (e.g., methods 200, 250 and 400).

In one embodiment, the scanning laser device 700 is a light LiDAR system used for object detection and/or 3D map generation. The scanning laser device 700 includes a laser light source 702 and an optical assembly 704. The optical assembly 704 is one example of the type of optical assembly that can be used in a LiDAR or other scanning laser device (e.g., scanning laser device 100) in accordance with the embodiments described herein. As such, the optical assembly 704 includes a variety of optical elements used to facilitate scanning. It should be noted that FIGS. 7A and 7B are simplified examples, and thus do not show all of the elements or features of a fully implemented scanning laser device or optical assembly.

The optical assembly 704 illustrated in FIG. 7A includes beam shaping optics 714, a first prism 716, a first scanning mirror assembly 717, first scanning mirror(s) 718, expansion optics that include three expansion lenses 720, 722, 724, a second prism 726, a second scanning mirror assembly 727, and second scanning mirror(s) 728.

During operation of scanning laser device 700 the laser light source 702 generates laser light pulses that are scanned by the optical assembly 704 into a scan trajectory. For example, the laser light source 702 can comprise one or more infrared (IR) lasers driven by field effect transistors (FETs) to generate IR laser light pulses.

In general, pulses from multiple IR laser light sources are first combined and shaped by the beam shaping optics 714 and associated optical elements. The beam shaping optics 714 can thus include any optics for changing the beam shape of the laser light pulses. For example, the beam shaping optics 714 can include collimating lenses, polarizing combiners, anamorphic prism pairs to improve divergence and other such elements. In one embodiment a pick-off beam splitter or prism 703 is implemented within the beam shaping optics 714 to direct reflections to the detector (not shown in FIGS. 7A and 7B) configured for relatively short-range pulse detection.

The output of the beam shaping optics 714 is passed to first prism 716 that kicks the beams up to the first scanning mirror 718. In this illustrated embodiment, the first scanning mirror 718 provides for horizontal scanning motion, while the second scanning mirror 728 provides for vertical scanning motion. Furthermore, in this example the first scanning mirror 718 is driven to provide the scanning motion at a relatively slow scan rate, while the second scanning mirror 728 is driven to provide motion at a a relatively slow scan rate. However, these are just examples, and other implementations are possible. Together, this scanning mirror motion results in the laser light pulses being scanned into scan trajectory. It again should be noted labels “vertical” and “horizontal” used herein are somewhat arbitrary, since a 90 degree rotation of the scanning laser device will effectively switch the horizontal and vertical axes.

The output of the first scanning mirror 718 is passed to the three expansion lenses 720, 722, 724 which together provide the expansion optics. In general, the expansion optics are implemented to provide an expansion of the scan field in the horizontal direction.

Specifically, in this illustrated example the three expansion lenses 720, 722, 724 are implemented to image the output of the first scanning mirror 718 onto the second scanning mirror 728 while providing a non-uniform expansion in the horizontal direction. As one specific example, the first scanning mirror 718 can be implemented to provide a scanning angle in the horizontal direction of 40 degrees, and the expansion lenses 720, 722, 724 can be implemented to provide a non-uniform expansion to expand the scanning angle to 110 degrees.

In one specific example, the three expansion lenses 720, 722, 724 implement a 4F optical system that images the output of the first scanning mirror 718 onto the second scanning mirror 728. Specifically, the three expansion lenses 720, 722, 724 provide a 4F optical system with magnification that varies with the angle coming from the first scanning mirror 718. The result of these three expansion lenses 720, 722, 724 is a non-uniform variation in optical expansion of the exit scan angle provided by the first scanning mirror 718. The second prism 726 receives the output of the third expansion lens 724 and directs the beams to the second scanning mirror 728.

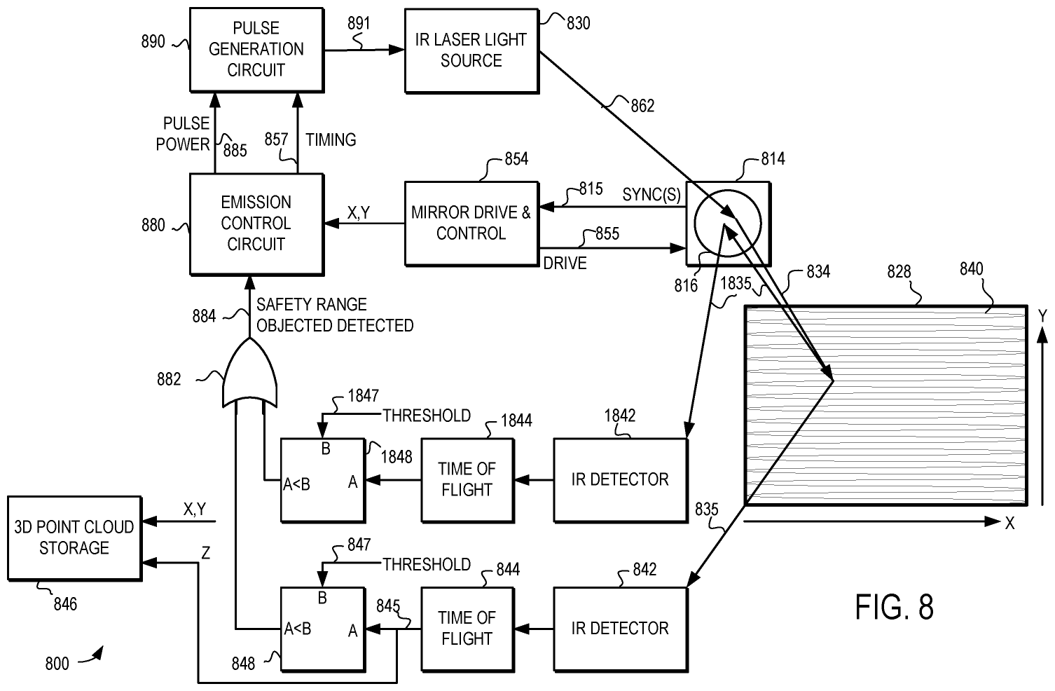

Turning now to FIG. 8, a scanning light detection and ranging (LiDAR) system 800 in accordance with various embodiments is illustrated. System 800 includes pulse generation circuit 890, infrared (IR) laser light source 830, scanning mirror assembly 814 with scanning mirror(s) 816, and mirror drive and control circuit 854. System 800 also includes first infrared (IR) detector 842, first time-of-flight (TOF) measurement circuit 844, 3D point cloud storage circuit 886, first comparator 848, and emission control circuit 880. System 800 also includes second IR detector 1842, second TOF measurement circuit 1844, and second comparator 1848. As will be described in greater detail below, the second IR detector 1842 can be implemented to provide redundant relatively short-range detection.

The LiDAR system 800 is another example of the type of scanning laser device that can be implemented in accordance with the embodiments described herein (e.g., methods 300, 350, 360). In this example, the emission control circuit 880 and pulse generation circuit 890 function as all or part of a light source controller, and thus controls the laser light source 830 to selectively emit relatively low energy emission control pulse sets that are used to detect when objects (e.g., persons) are within relatively close safety ranges. Then, higher energy long-range pulse sets are conditionally emitted only when objects are not detected within the first and second safety ranges, thus improving eye-safety.

Laser light source 830 may be a laser light source such as a laser diode(s) or the like, capable of emitting a laser beam pulses 862. The beam pulses 862 impinge on a scanning mirror assembly 814 which in some embodiments is part of a microelectromechanical system (MEMS) based scanner or the like, and reflects off of scanning mirror 816 to generate controlled output beam pulses 834. In some embodiments, optical elements are included in the light path between laser light source 830 and mirror(s) 816. For example, system 800 may include collimating lenses, dichroic mirrors, expansion optics, or any other suitable optical elements. And as was described above, the scanning mirrors, expansion optics, and other elements can cause back reflections of laser light pulses toward the second IR detector 1842 during operation of the system 800.

A scanning mirror drive and control circuit 854 provides one or more drive signal(s) 855 to control the angular motion of scanning mirror(s) 816 to cause output beam pulses 134 to traverse a scan trajectory 840 in a scan field 828. In operation, laser light source 830 produces modulated light pulses in the nonvisible spectrum and scanning mirror(s) 816 reflect the light pulses as beam pulses 834 traverse scan trajectory 840.

In some embodiments, scan trajectory 840 is formed by combining a sawtooth component on the horizontal axis and a sinusoidal component on the vertical axis. In still further embodiments, the horizontal sweep is also sinusoidal. The various embodiments of the present invention are not limited by the waveforms used to control the vertical and horizontal sweep or the resulting scan trajectory pattern. One axis (e.g., horizontal) is the slow scan axis, and the other axis is the fast-scan axis.

Although scanning mirror(s) 816 are illustrated as a single mirror that scans in two axes, this is not a limitation of the present invention. For example, in some embodiments, mirror(s) 816 is implemented with two separate scanning mirrors, one scanning in one axis, and a second scanning in a second axis.

In some embodiments, scanning mirror(s) 816 include one or more sensors to detect the angular position or angular extents of the mirror deflection (in one or both dimensions). For example, in some embodiments, scanning mirror assembly 814 includes a piezoresistive sensor that delivers a voltage that is proportional to the deflection of the mirror on the fast-scan axis. Further, in some embodiments, scanning mirror assembly 814 includes an additional piezoresistive sensor that delivers a voltage that is proportional to the deflection of the mirror on the slow-scan axis. The mirror position information is provided back to mirror drive and control circuit 854 as one or more SYNC signals 815. In these embodiments, mirror drive and control circuit 854 includes one or more feedback loops to modify the drive signals in response to the measured angular deflection of the mirror. In addition, in some embodiments, mirror drive and control circuit 854 includes one or more phase lock loop circuits that estimate the instantaneous angular position of the scanning mirror based on the SYNC signals.

Mirror drive and control circuit 854 may be implemented using functional circuits such as phase lock loops (PLLs), filters, adders, multipliers, registers, processors, memory, and the like. Accordingly, mirror drive and control circuit 854 may be implemented in hardware, software, or in any combination. For example, in some embodiments, control circuit 854 is implemented in an application specific integrated circuit (ASIC). Further, in some embodiments, some of the faster data path control is performed in an ASIC and overall control is software programmable.

The system 800 includes two separator IR detectors, TOF measurement circuits and comparators for detecting IR laser pulses. Specifically, the system 800 includes a first IR detector 842 and a second IR detector 1842. In general, the first IR detector 842 is implemented to detect reflections from both emission control pulse sets and ranging pulse sets, while the second IR detector provides for the redundant detection of reflections from the low power emission control pulse sets to provide increased eye safety.

First IR detector 842 includes one or more photosensitive devices capable of detecting reflections of IR laser light pulses. For example, first IR detector 842 may include one or more PIN photodiodes, Silicon photomultipliers (SiPM), avalanche photodiodes (APD), or the like. Each point in the field of view that is illuminated with an IR laser light pulse (referred to herein as a “measurement point”) may or may not reflect some amount of the incident light back to first IR detector 842. If first IR detector 842 detects a reflection, IR detector 842 provides a signal 843 to first TOF measurement circuit 844.

First TOF measurement circuit 844 measure times-of-flight (TOF) of IR laser light pulses to determine distances to objects in the field of view. In some embodiments, emission control circuit 880 provides a timing signal (not shown) corresponding to the emission time of a particular IR laser light pulse to first TOF measurement circuit 844, and first TOF measurement circuit 844 measures the TOF of IR laser light pulses by determining the elapsed time between the emission of the pulse and reception of the reflection of the same pulse.

First TOF measurement circuit 844 may be implemented using any suitable circuits. For example, in some embodiments, first TOF measurement circuit 844 includes an analog integrator that is reset when the IR pulse is launched, and is stopped when the reflected pulse is received. First TOF measurement circuit 844 may also include an analog-to-digital converter to convert the analog integrator output to a digital value that corresponds to the time-of-flight (TOF) of the IR laser pulse, which in turn corresponds to the distance between system 800 and the object in the field of view from which the laser light pulse was reflected.

3D point cloud storage device 846 receives X, Y data from mirror drive and control circuit 854, and receives distance (Z) data on node 845 from first TOF measurement circuit 844. A three-tuple (X,Y,Z) is written to 3D point cloud storage device for each detected reflection, resulting in a series of 3D points referred to herein as a “point cloud.” Not every X, Y measurement point in the field of view will necessarily have a corresponding Z measurement. Accordingly, the resulting point cloud may be sparse or may be dense. The amount of data included in the 3D point cloud is not a limitation of the present invention.

3D point cloud storage device 846 may be implemented using any suitable circuit structure. For example, in some embodiments, 3D point cloud storage device 846 is implemented in a dual port memory device that can be written on one port and read on a second port. In other embodiments, 3D point cloud storage device 846 is implemented as data structures in a general purpose memory device. In still further embodiments, 3D point cloud storage device 846 is implemented in an application specific integrated circuit (ASIC).

First comparator 848 compares the distance data (Z) on node 845 to a current threshold value, and if the distance is less than the current threshold value, then first comparator 848 asserts the safety range object detection signal on the input to OR gate 882. The safety range object detection signal passes through OR gate 882 to the emission control circuit 880 to indicate the detection of an object within a first or second safety range, where the first and second safety ranges are determined by values of the threshold on node 847. For example, if a first threshold is set to a value corresponding to a distance of five meters, and the detected distance is lower than that first threshold, then an object closer than five meters has been detected, and emission control circuit 880 will be notified by the safety range object detection signal on node 884. Likewise, if a second threshold is set to a value corresponding to a distance of ten meters, and the detected distance is lower than that second threshold, then an object closer than ten meters has been detected, and emission control circuit 880 will be notified by the safety range object detection signal on node 884.

The threshold values at node 847 and the corresponding safety range distances can be modified by emission control circuit 880 based on any criteria. For example, the thresholds may be a function of IR laser pulse power, pulse duration, pulse density, wavelength, scanner speed, desired laser safety classification, and the like. The manner in which the threshold values are determined is not a limitation.

The second IR detector 1842, second TOF measurement circuit 1844, and second comparator 1848 operate to provide a redundant detection capability for reflections of first and second emission control pulse sets from objects in the first and second safety ranges. Redundant detection of first and second emission control pulse sets provides an additional measure of safety. For example, if one or the IR detectors, TOF measurement circuits, or comparators should fail, the redundancy will ensure continued safe operation.

Notably, the first IR detector 842 and the second IR detector 1842 receive reflected light pulses through different optical paths. Specifically, the first IR detector 842 receives reflected light along a separate path shown at 835 while the second IR detector 1842 shares at least part of an optical path with the emitted light pulses. Specifically, the reflected light from the scan field is reflected back through at least some of the mirror(s) 816, expansion optics, and other elements in the optical assembly to reach second IR detector 1842 along path 1835.

The second TOF measurement circuit 1844 measure times-of-flight (TOF) of IR laser light pulses to determine distances to objects in the field of view in a manner similar to that of the first TOF measurement circuit 844. Thus, the second TOF measurement circuit 1844 may be implemented using any suitable circuits as with the first TOF measurement circuit 844.

Likewise, the second comparator 1848 compares the distance data (Z) on node 845 to a current threshold value, and if the distance is less than the current threshold value, then second comparator 1848 asserts the safety range object detection signal on the input to OR gate 882. Again, this safety range object detection signal passes through OR gate 882 to the emission control circuit 880 to indicate the detection of an object within a relatively short first or second safety range, where first and safety ranges are determined by the values of the threshold on node 1847.

Again, the threshold values at node 1847 and the corresponding safety range distances may be modified by emission control circuit 880 based on any criteria. For example, the threshold may be a function of IR laser pulse power, pulse duration, pulse density, wavelength, scanner speed, desired laser safety classification, and the like.

In some embodiments, both of the detection and TOF measurement circuits operate to detect short-range objects (e.g., objects in the safety range), and only one of the detection and TOF measurement circuits operate to measure long-range distance and/or write to the 3D cloud storage device. For example, in embodiments represented by FIG. 8, times-of-flight measured by either TOF measurement circuit 1844 or TOF measurement circuit 1844 may be used to detect an object in the safety range with an emission control pulse set, but only times-of-flight measured by TOF measurement circuit 844 are used to populate the 3D point cloud.

Emission control circuit 880 operates to manage accessible emission levels in a manner that allows overall operation to remain eye-safe. For example, in some embodiments, emission control circuit 880 controls whether a short-range first or second emission control pulse set or a long-range ranging pulse set is generated by setting a pulse set energy value on node 885. The emitted pulse set energy may be controlled by one or more of pulse power, pulse duration, or pulse count. Emission control circuit 880 can also control the timing of emitted pulses via the timing signal on node 857. For example, the emission control circuit can control the timing and energy of first and second emission control pulse sets and ranging pulse sets.

Emission control circuit 880 may be implemented using any suitable circuit structures. For example, in some embodiments, emission control circuit 880 may include one or more finite state machines implemented using digital logic to respond to object detection in a safety range and conditionally signal pulse generation circuit 890 to emit long-range pulse sets. Further, in some embodiments, emission control circuit 880 may include a processor and memory to provide software programmability of emission control and ranging pulse set energies, threshold values and the like. The manner in which emission control circuit 880 is implemented is not a limitation of the present invention.

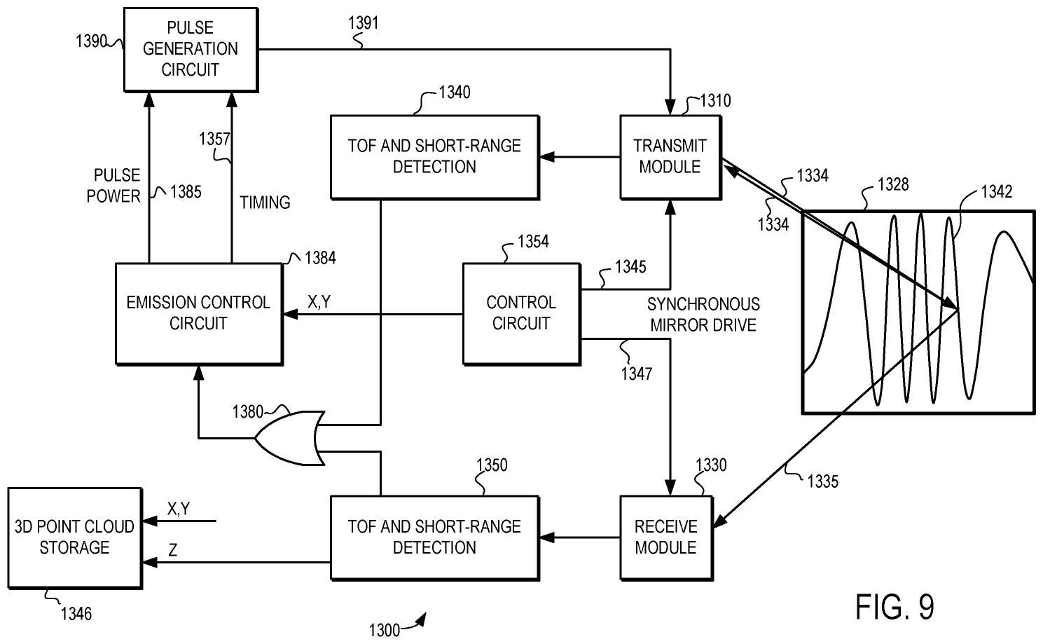

Turning now to FIG. 9, a scanning light detection and ranging (LiDAR) system 1300 in accordance with various embodiments is illustrated. LiDAR system 1300 includes emission control circuit 1384, pulse generation circuit 1390, 3D point cloud storage device 1346, OR gate 1380, and control circuit 1354. LiDAR system 1300 also includes transmit module 1310, receive module 1330, TOF and short-range detection circuits 1340, and TOF and short-range detection circuits 1350.

The LiDAR system 1300 is another example of the type of scanning laser device that can be implemented in accordance with the embodiments described herein (e.g., methods 300, 350, 360). In this example, the emission control circuit 1384, pulse generation circuit 1390 function as a light source controller, and specifically controls the transmit module 1310 to selectively emit relatively low energy first and second emission control pulse sets that are used to detect when objects (e.g., persons) are within relatively close first and second safety ranges. Then, higher energy long-range pulse sets are conditionally emitted only when objects are not detected within the first and second safety range, thus improving eye-safety.

The LiDAR system 1300 includes two separate IR detectors and TOF and short-range detection circuits for detecting reflections of IR laser pulses. Specifically, the receive module 1330 includes a first IR detector implemented to detect reflections from both short-range pulse sets (e.g., emission control pulse sets) and long-range pulse sets (e.g., ranging pules), while the transmit module 1310 includes a second IR detector that provides for the redundant detection of reflections from relatively low energy short-range emission control pulse sets to provide increased eye safety.

Transmit module 1310 includes an IR laser light source to produce a pulsed laser beam, collimating and focusing optics, and one or more scanning mirror assemblies implemented together in an optical assembly to scan the pulsed laser beam in two dimensions in the field of view. Transmit module 1310 also includes an IR laser light detector that shares an optical path with emitted IR laser light pulses. Example embodiments of transmit modules are described more fully below with reference to later figures.

Receive module 1330 includes optical devices and one or more scanning mirror assemblies to scan in two dimensions to direct reflected light from the field of view to an included IR light detector. Example embodiments of receive modules are described more fully below with reference to later figures.

Each of TOF and short-range detection circuits 1340 and 1350 include a TOF measurement circuit and comparator. For example, TOF and short-range detection circuits 1340 may include TOF circuit 1844 and second comparator 1848, and TOF and short-range detection circuits 1350 may include TOF measurement circuit 844 and comparator 848 (FIG. 8).

Control circuit 1354 controls the movement of scanning mirrors within transmit module 1310 as described above with reference to FIG. 8. Control circuit 1354 also controls the movement of scanning mirrors within receive module 1330. In operation, control circuit 1354 receives mirror position feedback information (not shown) from transmit module 1310, and also receives mirror position feedback information (not shown) from receive module 1330. The mirror position feedback information is used to phase lock the operation of the mirrors.

Control circuit 1354 drives microelectromechanical (MEMS) assemblies with scanning mirrors within transmit module 1310 with drive signal(s) 1345 and also drives MEMS assemblies with scanning mirrors within receive module 1330 with drive signal(s) 1347 that cause the mirrors to move through angular extents of mirror deflection that define the scan trajectory 1342 and the size and location of scan field 1328. The synchronization of transmit and receive scanning allows the receive aperture to only accept photons from the portion of the field of view where the transmitted energy was transmitted. This results in significant ambient light noise immunity.

The emission control circuit 1384 and pulse generation circuit 1390 control the timing and energies of the pulses emitted by transmit module 1310. For example, the pulse generation circuit 1390 can include a laser light source controller configured to vary the energy level of the laser light pulses emitted by the transmit module 1310. As such, the emission control circuit 1384 can be implemented to control the timing and energy of emitted emission control pulse sets and ranging pulse sets to implement the emission control methods 300 and 320 described above.

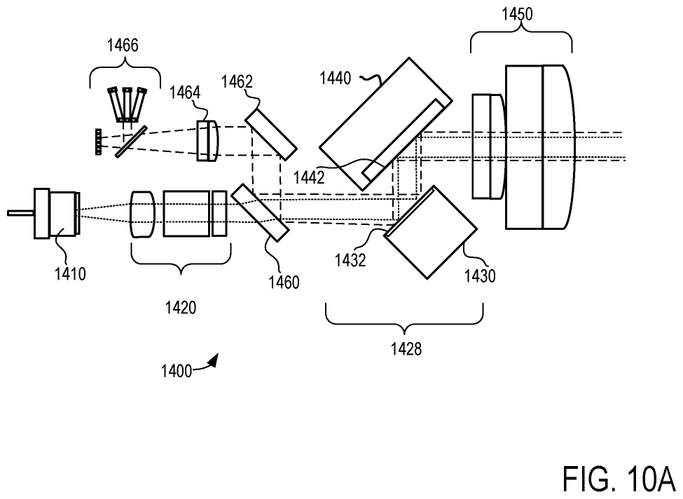

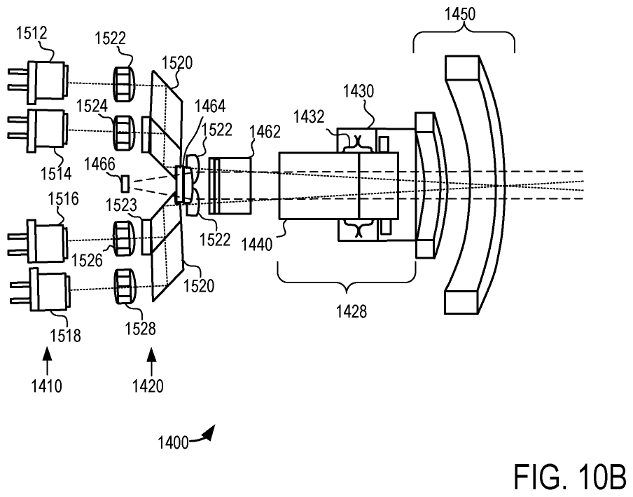

Turning now to FIGS. 10A and 10B, FIG. 10A shows a side view and FIG. 10B shows a top view of a transmit module 1400. Transmit module 1400 is an example of transmit module that can be used in a LiDAR system (e.g., transmit module 1310 of FIG. 9). Transmit module 1400 is thus another example of the type of device that can be implemented with emission control techniques described above (e.g., methods 300, 320). Transmit module 1400 includes laser light source 1410, beam shaping optical devices 1420, received energy pickoff device 1460, mirror 1462, beam shaping device 1464, IR detector 1466, scanner 1428, and exit optical devices 1450.

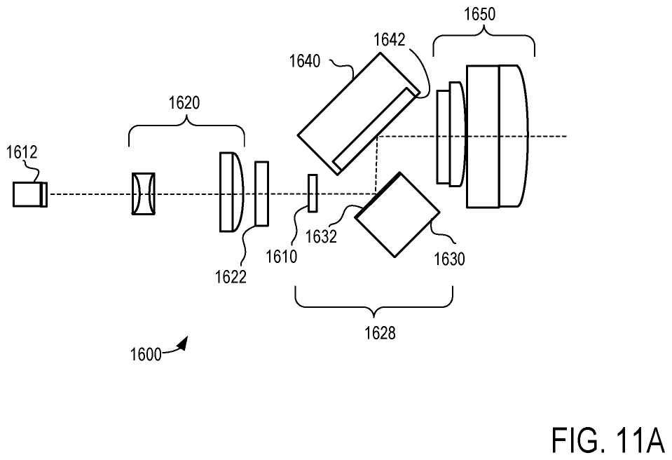

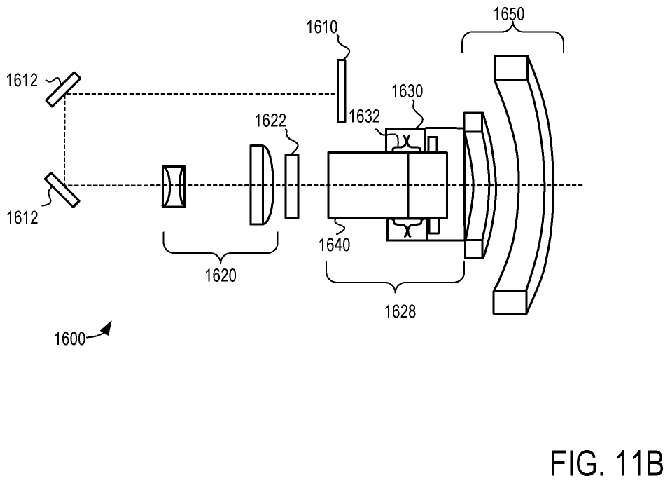

In some embodiments, laser light source 1410 sources generate nonvisible light such as infrared (IR) light. In these embodiments, IR detector 1466 detects the same wavelength of nonvisible light, as does an IR detector in receive module 1600 (FIG. 11, discussed below). For example, in some embodiments, laser light source 1410 may include a laser diode that produces infrared light with a wavelength of substantially 905 nanometers (nm), and IR detector 1466 detects reflected light pulses with a wavelength of substantially 905 nm. Also, for example, in some embodiments, laser light source 1410 may include a laser diode that produces infrared light with a wavelength of substantially 940 nanometers (nm), and IR detector 1466 detects reflected light pulses with a wavelength of substantially 940 nm. The wavelength of light is not a limitation of the present invention. Any wavelength, visible or nonvisible, may be used without departing from the scope of the present invention.

Laser light source 1410 may include any number or type of emitter suitable to produce a pulsed laser beam. For example, in some embodiments, laser light source 1410 includes multiple laser diodes shown in FIG. 10B at 1512, 1514, 1516, and 1518. The pulsed laser light produced by laser light source 1410 is combined, collimated, and focused by beam shaping optical devices 1420 to produce a pulsed laser beam. For example, optical devices 1522, 1524, 1526, 1528 may collimate the laser beams on the fast axis, polarization rotators 1523 and beam combiners 1520 may combine laser beams, and optical devices 1522 may form the pulsed laser beam into a fan on the slow axis. Beam sizes and divergence values are not necessarily uniform across the various embodiments of the present invention; some embodiments have higher values, and some embodiments have lower values.

Scanner 1428 receives the pulsed laser beam from optical devices 1420 and scans the pulsed beam in two dimensions. In embodiments represented by FIGS. 10A and 10B, scanner 1428 includes two separate scanning mirror assemblies 1430, 1440, each including a scanning mirror 1432, 1442, where each scanning mirror scans the beam in one dimension. For example, scanning mirror 1432 scans the pulsed beam in the fast scan direction, and scanning mirror 1442 scans the pulsed beam in the slow scan direction.

Although scanner 1428 is shown including two scanning mirror assemblies, where each assembly scans in a separate dimension, this is not a limitation of the present invention. For example, in some embodiments, scanner 1428 is implemented using a single biaxial scanning mirror assembly that scans in two dimensions. In some embodiments, scanning devices uses electromagnetic actuation, achieved using a miniature assembly containing a MEMS die and small subassemblies of permanent magnets and an electrical interface, although the various embodiments are not limited in this respect.

Exit optical devices 1450 operate on the scanning pulsed laser beam as it leaves the transmit module. In some embodiments, exit optical devices 1450 perform field expansion. For example, scanner 1428 may scan through maximum angular extents of 20 degrees on the fast scan axis, and may scan through maximum angular extents of 40 degrees on the slow scan axis, and exit optical devices 1450 may expand the field of view to 30 degrees on the fast scan axis and 120 degrees on the slow scan axis. The relationship between scan angles of scanning mirrors and the amount of field expansion provided by exit optical devices 1450 is not a limitation of the present invention.

Received energy pickoff device 1460 deflects received light (shown as a dotted line) that shares at least part of the transmit optical path with the emitted light pulses (shown as a solid line). The deflected received light is then reflected by mirror 1462, focused by optical device 1064, and detected by IR detector 1466. In some embodiments, pickoff device 1460 includes a “window” that transmits the pulsed beam produced by the IR laser light source, and a reflective outer portion to deflect received energy outside the window. In other embodiments, pickoff device 1460 is a partial reflector that transmits a portion of incident light and reflects the rest. For example, a reflector that transmits 90% of incident light and reflects 10% of incident light will provide the IR detector 1466 with 10% of the light reflected off an object in the field of view. In still further embodiments, pickoff device 1460 may incorporate a polarizing beam splitter that transmits the pulsed laser beam (at a first polarization), and picks off received light of a different polarization. This is effective, in part, due to the reflections being randomly polarized due to Lambertian reflection. In still further embodiments, the outgoing laser beam and received energy may be directed to different portions of the scanning mirrors, and pickoff device 1460 may be an offset mirror positioned to reflect one but not the other.

Again, to facilitate reliable detection of low energy emission control pulse sets the IR detector 1466 can be implemented with multiple sensors configured to receive reflections through at least some of the same optical assembly used to transmit laser light pulses into the scan field. Specifically, the IR detector 1466 can be configured to receive laser light pulses through the same scanning mirrors 1432, 1142, exit optical devices 1450, and other optical elements used to transmit the laser light pulses into the scan field. Because the same optical assembly is used by the multiple sensors to receive the laser light reflections any damage or blockage that prevents the multiple sensors from receiving the reflections from emission control pulse sets would also have likely blocked the scanning of the laser light pulses into the scan field. Thus, the IR detector 1466 can more reliably detect emission control pulse sets that have impacted an object in the safety range of the scan field and reflected back toward the detector, and can thus be used to reliably determine when long-range pulse sets can be emitted safely. Furthermore, the multiple sensors in the IR detector 1466 are configured to at least partially cancel the effects of back reflections from within the optical assembly. The cancellation of the effects of back reflections from within the optical assembly can improve the sensitivity of the detector, particularly for the detection of low energy emission control reflections from within the scan field.

Also as described above, the transmit module 1400 can be implemented with a laser light source controller configured to vary the energy level of the laser light pulse sets according to position along the first axis of the scan field. The variation of the energy level of the laser light pulse sets is performed provide the desired effective range of the sensor while at least partially compensating for the effects of the non-uniform optical expansion provided by the expansion optics. For example, in one embodiment the light source controller is configured to vary the energy in a manner proportional to the non-uniform variation in optical expansion. Thus, laser light pulses that are subjected to greater optical expansion are generated with greater energy levels. Additionally, the laser light source controller can be configured to vary the energy to facilitate different effective ranges in different scan regions of the scan field.

Turning now to FIGS. 11A and 11B, FIG. 11A shows a side view and FIG. 11B shows a top view of a receive module 1600. Receive module 1600 is an example of receive module that can be used in a LiDAR system (e.g., receive module 1330 of FIG. 9). Receive module 1600 is thus another example of the type of device that can be implemented with emission control techniques described above (e.g., methods 300, 350, 360). Receive module 1600 includes IR detector 1610, fold mirrors 1612, imaging optical devices 1620, bandpass filter 1622, scanner 1628, and exit optical devices 1650.

Scanning mirror assemblies 1630 and 1640 are similar or identical to scanning mirror assemblies 1430 and 1440, and exit optical devices 1650 are similar or identical to exit optical devices 1450. Bandpass filter 1422 passes the wavelength of light that is produced by laser light source 1410, and blocks ambient light of other wavelengths. For example, in some embodiments, the laser light source produces light at 905 nm, and bandpass filter 1622 passes light at 905 nm.

Imaging optical devices 1620 image a portion of the field of view onto IR detector 1610 after reflection by fold mirrors 1612. Because scanner 1628 is scanned synchronously with scanner 1428, detector 1610 always collects light from the measurement points illuminated by the scanned pulsed beam.

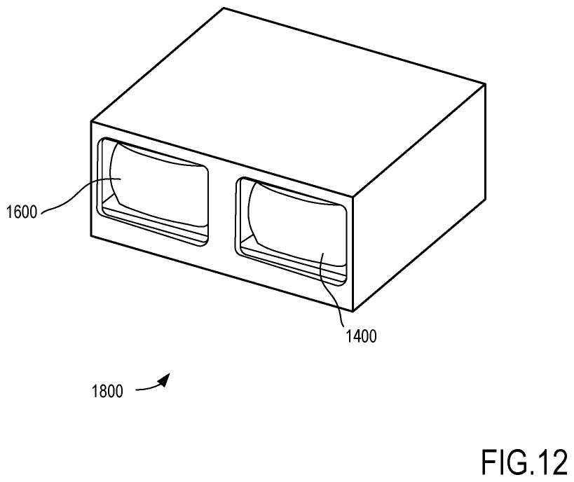

FIG. 12 shows a perspective view of an integrated photonics module in accordance with various embodiments of the present invention. Integrated photonics module 1800 includes both transmit module 1400 (FIGS. 10A and 10B) and receive module 1600 (FIGS. 11A and 11B). Integrated photonics module 1800 is shown having a rectangular housing with transmit module 1400 and receive module 1600 placed side by side. In some embodiments, transmit module 1400 and receive module 1600 are placed one on top of the other.

In the preceding detailed description, reference was made to the accompanying drawings that show, by way of illustration, specific embodiments in which the invention may be practiced. These embodiments were described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The preceding detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

1. An apparatus comprising:
a laser light source configured to produce laser light pulses;
an optical assembly, the optical assembly including beam scanning optics to scan the laser light pulses in a scan field, where the scan field includes a slow-scan axis and a fast-scan axis;
a detector to detect reflections of the laser light pulses from measurement points in the scan field; and
at least one controller coupled to the at least the laser light source and the detector, the at least one controller adapted to:
scan first measurement points with laser light pulses to generate a first plurality of distance measurements during a first sweep along the slow-scan axis based on times-of-flight of detected reflections;
interpolate first distance measurements in the first plurality of distance measurements to determine a first plurality of distance estimates;
scan second measurement points with laser light pulses to generate a second plurality of distance measurements during a second sweep along the slow-scan axis based on times-of-flight of detected reflections; and
compare distance estimates in the first plurality of distance estimates to distance measurements in the second plurality of distance measurements to determine radial velocity estimates for corresponding measurement points.

2. The apparatus of claim 1, wherein the at least one controller is further adapted to:
interpolate second distance measurements in the second plurality of distance measurements to determine a second plurality of distance estimates; and
compare distance estimates in the second plurality of distance estimates to distance measurements in the first plurality of distance measurements to determine radial velocity estimates for corresponding measurement points.

3. The apparatus of claim 1, wherein the at least one controller is adapted to compare the distance estimates in the first plurality of distance estimates to the distance measurements in the second plurality of distance measurements to determine the radial velocity estimates for the corresponding measurement points by being adapted to:
interpolate second distance measurements in the second plurality of distance measurements to determine a second plurality of distance estimates; and
compare distance estimates in the second plurality of distance estimates to distance measurements in the first plurality of distance measurements to determine radial velocity estimates for corresponding measurement points.

4. The apparatus of claim 1, wherein the at least one controller is further adapted to determine a surface-normal velocity from at least one of the radial velocity estimates.

5. The apparatus of claim 1, wherein the at least one controller is further adapted to determine a surface-normal velocity from at least one of the radial velocity estimates by being adapted to:
determine a surface-normal vector of a surface at the measurement point; and
project the at least one radial velocity estimate onto the surface-normal vector.

6. The apparatus of claim 1, wherein the laser light source comprises a transmitting unit with an array of emitter elements and wherein the detector comprises a receiving unit with an array of sensor elements.

7. The apparatus of claim 6, wherein the array of emitter elements are configured in a first focal-plane array arrangement and wherein the array of sensor elements are configured in a second focal-plane arrangement.

8. The apparatus of claim 1, wherein the apparatus further comprises a time-of-flight (TOF) circuitry responsive to the detector to determine distances to the measurement points in the scan field from the detected reflections.

9. The apparatus of claim 1, wherein the first sweep along the slow-scan axis precedes and it is temporally adjacent to the second sweep along the slow-scan axis.

10. The apparatus of claim 1, wherein the second sweep along the slow-scan axis precedes and it is temporally adjacent to the first sweep along the slow-scan axis.

11. The apparatus of claim 1, wherein the first sweep along the slow-scan axis comprises a forward sweep and wherein the second sweep along the slow-scan axis comprises a return sweep.

12. A laser scanning method, where laser scanning method comprises:
scanning first measurement points with laser light pulses to generate a first plurality of distance measurements during a first sweep along the slow-scan axis based on times-of-flight of detected reflections;
interpolating first distance measurements in the first plurality of distance measurements to determine a first plurality of distance estimates;
scanning second measurement points with laser light pulses to generate a second plurality of distance measurements during a second sweep along the slow-scan axis based on times-of-flight of detected reflections; and
comparing distance estimates in the first plurality of distance estimates to distance measurements in the second plurality of distance measurements to determine radial velocity estimates for corresponding measurement points.

13. The method of claim 12, further comprising:
interpolating second distance measurements in the second plurality of distance measurements to determine a second plurality of distance estimates; and
comparing distance estimates in the second plurality of distance estimates to distance measurements in the first plurality of distance measurements to determine radial velocity estimates for corresponding measurement points.

14. The method of claim 12, wherein the comparing the distance estimates in the first plurality of distance estimates to the distance measurements in the second plurality of distance measurements to determine the radial velocity estimates for the corresponding measurement points comprises:
interpolating second distance measurements in the second plurality of distance measurements to determine a second plurality of distance estimates; and
comparing distance estimates in the second plurality of distance estimates to distance measurements in the first plurality of distance measurements to determine radial velocity estimates for corresponding measurement points.

15. The method of claim 12 further comprising determining a surface-normal velocity from at least one of the radial velocity estimates.

16. The method of claim 12, further comprising:
determining a surface-normal vector of a surface at a measurement point from at least one radial velocity estimate; and
projecting the at least one radial velocity estimate onto the surface-normal vector to determine a surface-normal velocity.

17. The method of claim 12, wherein the first sweep along the slow-scan axis precedes and it is temporally adjacent to the second sweep along the slow-scan axis.

18. The method of claim 12, wherein the second sweep along the slow-scan axis precedes and it is temporally adjacent to the first sweep along the slow-scan axis.

19. The method of claim 12, wherein the first sweep along the slow-scan axis comprises a forward sweep and wherein the second sweep along the slow-scan axis comprises a return sweep.

20. An apparatus comprising:
a laser light source configured to produce laser light pulses;
an optical assembly, the optical assembly including at least one scanning mirror to scan the laser light pulses in a scan pattern over a scan field, where the scan field includes a slow-scan axis and a fast-scan axis;
a detector to detect reflections of the laser light pulses from measurement points in the scan field;
at least one controller coupled to the at least the laser light source, the at least one scanning mirror and the detector, the at least one controller adapted to:
scan first measurement points with laser light pulses to generate a first plurality of distance measurements during a forward sweep along the slow-scan axis based on times-of-flight of detected reflections;
interpolate first distance measurements in the first plurality of distance measurements to determine a first plurality of distance estimates;
scan second measurement points with laser light pulses to generate a second plurality of distance measurements during a return sweep along the slow-scan axis based on times-of-flight of detected reflections, and where the return sweep along the slow-scan axis is temporally adjacent and in opposite direction of the forward sweep along the slow-scan axis; and
compare distance estimates in the first plurality of distance estimates to distance measurements in the second plurality of distance measurements to determine radial velocity estimates for corresponding measurement points.
